(19) United States
(12) Patent Application Publication
(10) Pub. No.: US 2026/0192697 A1
(43) Pub. Date: Jul. 9, 2026

(54) Bidirectional Charging of an Electric Vehicle

(71) Applicant: Bayerische Motoren Werke Aktiengesellschaft, Muenchen (DE)

(72) Inventors: Jens BERGER, Muenchen (DE); Mark PILKINGTON, Muenchen (DE)

(21) Appl. No.: 19/131,285

(22) PCT Filed: Nov. 6, 2023
(86) PCT No.: PCT/DE2023/100816

§ 371 Date: May 20, 2025

(30) Foreign Application Priority Data
Nov. 21, 2022 (DE) 10 2022 130 660.7

(51) Int. Cl. B60L 53/64; B60L 53/62; B60L 55/00; G06Q 50/06; H02J 3/32

(52) U.S. Cl. CPC B60L 53/64; B60L 53/62; B60L 55/00; G06Q 50/06; H02J 3/322

(57) ABSTRACT

The present disclosure relates to a method for bidirectionally charging an electric vehicle provided with a traction battery system having a traction battery and a charge-electronics system for charging the traction battery, wherein the method provides for battery charging wear costs and charge-electronics charging wear costs of the traction battery system to be determined prior to the charging process and for a discharging of the traction battery to be prevented at least during periods of a charging process in which an associated discharge revenue is not greater than both charging wear costs by at least one respective predefined margin.

### BACKGROUND AND SUMMARY

The present disclosure concerns a method for bidirectional charging of an electric vehicle equipped with a traction battery, wherein battery charging wear costs of the traction battery are determined, a discharge solution for discharging the traction battery is determined, and then, if the discharge solution is not greater than the battery charging wear costs, discharging is prevented at least for the duration of this condition.

The present disclosure also concerns an electric vehicle with a traction battery system for which the electric vehicle is designed for bidirectional charging of its traction battery and for which the electric vehicle is designed to carry out the method. The present disclosure also concerns a system comprising an electric vehicle and an external data processing instance that can be communicatively coupled to the electric vehicle, wherein the system 10 is designed to carry out the process. The present disclosure is particularly advantageous for use in fully electric vehicles.

U.S. Pat. No. 10,026,134 B2 discloses a charging and discharging scheduling method for electric vehicles in local energy grids (also referred to as “microgrids”) at time-of-usage prices, which comprises: determining the system structure of the microgrid and the characteristics of each unit; setting up an optimal scheduling objective function of the microgrid, taking into account the depreciation costs of the battery of the electric vehicle under the service life price; determining the constraints of each divided generator and battery of an electric vehicle and images of an optimum scheduling model of the microgrid together with the optimal planning objective function of the microgrid; determining the amount, start and end time, of the start and end charging state, and other fundamental calculation data of the electric vehicle accessing the microgrid under the time-of-use price; determining the charging and discharging power of the electric vehicle when connected to the microgrid solving the optimal utilization scheduling model of the microgrid using a particle swarm optimization algorithm. The depreciation costs C_{BAT} of the battery for an electric vehicle are calculated as follows:

$${C}_{BAT} = \frac{{C}_{REP}}{{E}_{PUT}} {\int }_{{t}_{1}}^{{t}_{2}} \vert P ( t ) \vert dt$$

where C_{REP} is the battery replacement costs, E_{PUT} the total energy throughput during the service life of the battery, t₁ and t₂ the start and end times of a connection period to the microgrid and P the charging or discharging power during the connection period. The corresponding sum is shown for several electric vehicles.

CN 109713696 B aims at a daily optimization planning problem of a photovoltaic charging station system for charging electric vehicles and creates a life cycle model of the traction battery based on the experimental data of the battery and using a B-Spline interpolation function. Based on this, an optimal “Day-Ahead Scheduling” method is proposed that takes into account the influence of the battery life of electric vehicles on the discharging behavior of users in V2G mode. Photovoltaic charging stations for electric vehicles are located in residential areas and supply electric vehicles with electrical energy through slow charging. During peak electricity price periods electric vehicles can sell electricity to the public energy supply grid for revenue. During this process, the V2G discharge costs of the traction battery connected to a photovoltaic charging station during peak electricity price periods are taken into account. The V2G discharge costs, W, take into account a current state of charge and an ambient temperature of the traction battery. They can be calculated according to the following formulas.

$$W = \frac{{C}_{z}}{Γ} , F = L \cdot {C}_{R}$$

where C_{z} is the acquisition cost of the traction battery, Γ=the current throughput of the traction battery, L the battery service life and C_{R} the nominal capacity of the traction battery.

The (current) battery service life L is a function of the nominal service life, the current state of charge and the current ambient temperature.

The discharge loss costs are compared with the feed-in revenue paid by the public energy supply grid. If the discharge loss costs of the electric vehicle are higher than the feed-in revenue, users of electric vehicles will not participate in the V2G mode; otherwise, they will participate in the V2G mode and supply the public energy grid with energy during peak times.

It is an object of the present invention to at least partially overcome the disadvantages of the prior art and, in particular, to provide a particularly simple way of taking battery charging wear costs into account when discharging a traction battery of an electric vehicle.

This object is achieved in accordance with the features of the independent claim. Preferred embodiments can be derived, in particular, from the dependent claims.

The object is achieved by a method for bidirectional charging of a vehicle equipped with a traction battery system, wherein the traction battery system comprises a traction battery and charging electronics configured for charging. (i.e. charging and discharging) the traction battery, where
battery charging wear costs, W_{bat}, and charging electronics charging wear costs, Wₑₗₑ, of the traction battery system are determined and
discharging of a traction battery during the charging process is prevented at least for periods of time in which the discharge revenue is not greater than both charging wear costs by at least a given margin,
   whereby the battery charging wear costs are calculated according to

$${W}_{bat} = \frac{{C}_{bat}}{{E}_{rated}} Δ {E}_{dis}$$

and the electronic charging wear costs according to

$${W}_{ele} = \frac{{C}_{ele}}{{L}_{rated}} Δ {t}_{dis}$$

where C_{bat} is the acquisition cost or a value of the traction battery, E_{rated} is the estimated (nominal) total energy throughput of the traction battery over its lifetime, ΔE_{dis} the energy throughput during discharge, Cₑₗₑ the acquisition cost or a value of the energy throughput during a charging (i.e., charging and discharging) process with electronic components in operation (“charging electronics”), L_{rated} the estimated (rated) operating life of the charging electronics and Δtdis the duration of the discharge. The charging electronics include, for example, the battery electronics and/or other vehicle components that were put to use for a charging process.

The estimated nominal total energy E_{rated} throughput is usually known, for example it is specified by the manufacturer. The estimated (nominal) L_{rated} operating life of the charging electronics is also specified and typically comprises the operating hours that the charging electronics can be nominally operated within its service life. The (nominal) L_{rated} operating life of the charging electronics can be specified in hours, for example. Typical ex-works operating times are currently approx. 33,000 hours for most vehicles.

The method takes into account that the traction battery and the charging electronics are components that limit the service life of the traction battery system independently of each other. The different wear drivers of battery and electronics are specifically taken into account, namely for the battery specifically all the energy throughput and for the charging electronics mainly all the operating times are taken into account, whereby a more precise estimate of the charging wear costs can be made easily by simple means and thus a particularly reliable decision can be made as to whether a discharging process is worthwhile. In the above method, the calculation of the battery charging consumption, the energy throughput ΔE_{dis} for a discharging process is taken into account when calculating the electronic charging wear costs, and the operating time Δtdis during a discharging process is taken into account when calculating the electronic charging wear costs.

The fact that discharging of the traction battery is prevented if a discharge rate is not at least within a specified margin greater than both loading wear costs, can also be expressed as a way that discharging of the traction battery is prevented if even only one of the two charging wear costs is less than the discharge revenue plus the respective specified margin, or that the traction battery is only discharged during the charging process if the discharge revenue is less than at least the respective specified margin, or the income exceeds the specified margin by at least the sum of the two loading wear costs. This can be implemented, for example, in such a way that an otherwise occurring discharge phase is shortened or even completely prevented.

The traction battery system is available in particular as a traction battery module and can be installed in particular as a single unit (“module”).

Bidirectional charging includes the option of charging or discharging a traction battery of the electric vehicle at a charging point. By discharging, the electrical energy taken from the traction battery can be fed into a public energy supply network (also called “Vehicle-to-Grid”, V2G) and/or fed into a local energy system, for example of a property (also called “Vehicle-to-Home”, V2H). The charging process refers to the charging operation performed during a connection period of the electric vehicle at a charging point. The charging process can have at least one charging phase, at least one discharging phase and possibly also at least one rest phase without charging (i.e. without charging or discharging). The energy throughput ΔE_{dis} while discharging with a variable discharge performance P_{dis} between the start time t₁ and the end time t₂ can be calculated like this, for example

$$Δ {E}_{dis} = {\int }_{{t}_{1}}^{{t}_{2}} \vert {P}_{dis} ( t ) \vert dt$$

The electric vehicle can be a hybrid vehicle, for example a plug-in hybrid vehicle, PHEV, or a fully electrically powered vehicle, BEV. The electric vehicle can be charged, i.e. charged or discharged, from a charging point, which is also set up for bidirectional charging. Charging can be performed through a charging cable or inductively.

The charging point can, for example, be a public charging station, a wallbox or an inductive parking space.

It is a further development that the charging wear costs are or have been determined before the charging process. This specifically simplifies the calculation of battery charging costs. Based on this, the charging wear costs can be calculated after an upcoming charging process has been detected (e.g. triggered by the request for a charging process, for example by pairing the electric vehicle with a charging station), but can also be determined independently of a specific charging process.

The method is particularly advantageous if a charging unit is or has been used for the charging process plan with at least one discharging phase and therefore the load profile including the discharging duration for the charging process is known in advance. If the unloading income is below the respective loading wear costs, the unloading phase is not implemented in a further development. If the charging plan is updated, the procedure can be used in the same way.

If a charging plan is set up by an entity external to the vehicle, such as an energy management system, and the electric vehicle can communicate with this external entity (e.g. when connected to a charging point via this charging point), the variables C_{bat}, L_{rated}, Cₑₗₑ and L_{rated} can be sent to the entity external to the vehicle in a further development, so that it can set up a charging plan which, in addition to forecast data, also takes into account the discharge income and the charging wear costs and only schedules discharge phases when it is worthwhile. It is a further development that the electric vehicle is connected to a charging point and a charging plan is set up, in which no discharging is scheduled, at least for those time periods or periods of the connection period in which the discharge revenue is not greater than the charging wear costs by at least a predetermined margin. The electric vehicle can then be charged according to this charging plan. In particular, the variables C_{bat}, E_{rated}, Cₑₗₑ and L_{rated} are assumed to be constant for the duration of the charging plan.

The discharge revenue, π_{dis} corresponds in particular to monetary revenue or profit resulting from the delivery of electrical energy when discharging. In the V2G case, the discharge revenue corresponds, for example, to the feed-in tariff set by the operator of the energy supply grid. The discharge revenue can be specified for example in € or in € per kWh. It can be constant or vary over a connection period during which the electric vehicle can be charged at the charging point, for example depending on the time of day.

The condition that the discharge revenue, πdis, is not greater than the battery charging wear costs, W_{bat}, by at least a predetermined margin M_{bat}, can also be expressed as πdis>W_{bat}+M_{bat}. For the M_{bat} margin the condition of M_{bat}≥0 applies, and in a further development also M_{bat}=0. M_{bat}=0 includes the case where discharging is worthwhile for a user if the discharge revenue xdis is greater than the battery charging wear costs W_{bat}. With M_{bat}>0, discharging is only worthwhile for a user if the discharge revenue is noticeably greater (namely the M_{bat} margin) than the battery charging wear costs. This makes it possible to take into account, for example, that discharging can extend the time it takes to charge the traction battery to a desired target state of charge. The above condition can be applied analogously to the electronics charging wear costs Wₑₗₑ with the margin Mₑₗₑ. It can apply to a further development M_{bat}=Mₑₗₑ, or alternatively M_{bat} #Mₑₗₑ.

A simple example calculation illustrates the process: An electric vehicle is connected to a charging point and is charged using a charging plan that provides for a discharge time Δt_{dis} of 2 hours (Cₑₗₑ/L_{rated}) amounting to 0.5€/h. The Wₑₗₑ charging electronics charging wear costs would then amount to €1 for two hours of discharging. Neglecting the Mele margin, it would therefore be worth discharging during the connection period from the charging electronics' point of view and consequently only be approved if the discharging revenue πdis is greater than €1.

The battery charging wear costs W_{bat} should consequently amount to (Chat/E_{rated})=0.1€/kWh. If an energy throughput of ΔE_{dis} of 20 kWh is generated during discharging, the battery charging wear costs will be W_{bat}=2 €. Neglecting the margin M_{bat}, discharging would then only be worthwhile from the perspective of the traction battery and therefore only be approved if the discharge revenue M_{bat} is greater than 2€. If, on the other hand, discharging generates an energy throughput of ΔE_{dis} of 100 kWh, the battery charging costs are W_{bat}=10 €, and discharging during the charging process would only be worthwhile and consequently only be approved if the discharge revenue πdis is greater than 10 €.

It is a feature that the rated total energy throughput E_{rated} is modified or adjusted on the basis of at least one influencing variable affecting wear, in particular aging. This results in a more realistic calculation of the battery charge wear costs W_{bat}, which is particularly advantageous if the real use of the traction battery deviates significantly from the usage determination of the nominal total E_{rated} energy throughput of the initially estimated or assumed usage behavior deviates noticeably.

It is a design that the nominal total energy throughput depends on at least one influencing variable from the group of influencing variables
Battery temperature while charging;
Battery temperature during downtimes
The power of the charging or discharging processes
Calendar ageing. The older the traction battery, the lower it tends to allow for the possibility of applying E_{rated}.
Average storage level and/or
periods with high storage levels.

It is a design that the nominal operating life L_{rated} of the charging electronics is adapted or adjusted based on at least one influencing variable that influences the wear of the charging electronics, in particular ageing. This way, the charging electronics charging wear costs can be adapted to a real usage behavior of the electric vehicle, which is particularly advantageous if the real usage of the charging electronics deviates noticeably from the initially estimated or assumed usage behavior.

One design is that the rated operating life L_{rated} is dependent on at least one influencing variable from the group of influencing variables
Number of charging phases or cycles;
Power during the charging processes (i.e. charging and discharging processes);
Calendar ageing;
Temperature during the charging processes. The higher the temperature of the charging electronics during operation, the more it ages;
Temperatures during downtimes.

One design is that the electric vehicle is connected to a charging point, specifically a wallbox of a local energy grid, specifically a home electrical system, to perform the charging process and that “charging point” charging wear costs W_{EVSE} are calculated based

$${W}_{EVSE} = \frac{{C}_{EVSE}}{{L}_{evse , rated}} Δ {t}_{dis}$$

where C_{EVSE} represents the acquisition costs or value or the charging points or its electronics; L_{evse,rated} represents the estimated (nominal) operating life of the (Nominal) Operating power of the charging point, in particular its electronics, and Δt_{dis} corresponds to the duration of the discharging. This is analogous to the charging electronics charging wear costs Wₑₗₑ, especially since the service life of a charging point's electronics is the limiting factor. The charging point charging wear costs W_{EVSE} can be taken into account in such a way for example, that instead of Wₑₗₑ the sum W_{sys}=Wₑₗₑ+W_{EVSE} is compared to the discharge income πdis, and if the discharge revenue πdis is not greater than the charging system charging wear costs W_{sys} by at least a predetermined margin, discharging during the charging process is prevented at least for the duration of this condition. This configuration advantageously extends the consideration of the charging electronics charging wear costs because of the wear and tear of the charging point that then also occurs.

This is particularly advantageous if it involves the user of an electric vehicle, the operator of the local energy grid, or a homeowner. This configuration can be implemented in the same way as the aspects described above.

It is a design that the acquisition costs C_{bat}, Cₑₗₑ and/or C_{EVSE} and/or the nominal values E_{rated}, L_{rated} and/or L_{EVSE}, rated are adjusted regularly. This allows the charging wear costs to be advantageously adapted to a real usage behavior without any noticeable increase in computational effort. In particular, the adjustment can be carried out at predetermined, especially equal, intervals, for example every hour or after several hours, for example 12 hours, days, weeks or months, and especially not event-driven, for example because a charging process is pending. This system takes advantage of the fact that, especially after a certain time since the traction battery system and/or the charging point was first used, major deviations from a previous charging process that may have occurred only recently do not have a significant effect on the charging wear costs, so that the previously valid charging wear costs are still valid with a high degree of accuracy.

One design is that C_{bat}, Cₑₗₑ and/or C_{EVSE} and/or the nominal values E_{rated}, L_{rated} and/or L_{evse,rated} can be adapted through an external data processing instance that can be paired communicatively with the electric vehicle. This has the advantage that the computing power for adapting the above variables does not need to be provided by the electric vehicle. Instead, an external data processing instance can be used, which provides a high computing power, e.g. a network server or a cloud computer. This also facilitates the potential adjustment of the nominal values using more complex calculations. In particular, values or data relating to at least one influencing variable can be transmitted from the electric vehicle and/or the charging point to the external data processing instance, which uses them to calculate the adjusted nominal variable. These adapted variables can be transmitted to the electric vehicle and/or to other instances that can set up a charging plan for the electric vehicle, e.g. the charging point and/or an energy management system. In addition, the external data processing instance can be used advantageously to centrally manage and adjust acquisition costs and/or nominal values, e.g. by taking into account changing costs or values on the traction battery or charging electronics markets, etc.

The procedure can similarly be applied to several simultaneously considered electric vehicles (“pooling”). If several electric vehicles are pooled, the sum of the electric vehicles defines the wear costs.

The problem is also solved by an electric vehicle with a traction battery system, wherein the electric vehicle is set up for bidirectional charging of its traction battery and wherein the electric vehicle is set up to carry out the method as described above. The electric vehicle can be designed in the same way as the method and vice versa, and has the same advantages.

The problem is also solved by a system with an electric vehicle as described above and an external data processing instance, which can be communicatively paired with the electric vehicle and which is set up to adjust at least one of the acquisition cost of the data processing instances and/or at least one of the nominal values, whereby the system is set up to carry out the method as described above. The system can be designed analogously to the electric vehicle and/or the method, and vice versa, and has the same advantages.

It is a design that the system additionally comprises: a local energy grid with a charging point that is set up for bidirectional charging of the electric vehicle, and at least one regenerative energy generation device, wherein the discharge proceeds shall be determined by taking into account any energy fed into the local energy grid by the energy generation facility and/or by the energy purchase/feed-in tariff into the public electricity grid. This has the advantage that the vehicle can also be charged by the energy generation if the local energy grid is equipped with a stationary buffer storage device, and, if necessary, also from this. This enables a particularly efficient use of electrical energy to supply energy to consumers connected to the local energy grid, such as a property like a single-family home, and to feed it into a public electricity distribution grid.

The regenerative energy generation device can be a wind turbine or a photovoltaic system, for example.

The features, characteristics and advantages of the present invention described above and the manner in which they are achieved will become clearer and more comprehensible in connection with the following schematic description of a design example, which will be explained in more detail in connection with the drawings.

### BRIEF DESCRIPTION OF THE DRAWINGS

FIG. 1 shows a sketch of a charging infrastructure for charging an electric vehicle; and

FIG. 2 shows a possible sequence for creating a charging plan using the charging infrastructure from FIG. 1.

### DETAILED DESCRIPTION OF THE DRAWINGS

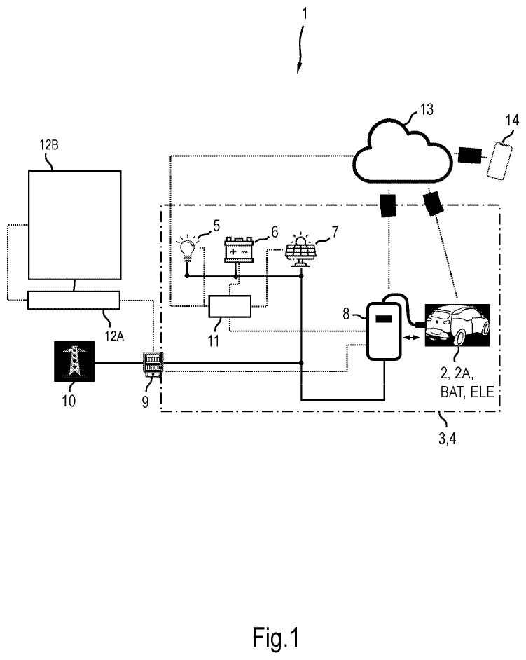

FIG. 1 shows a sketch of a charging infrastructure 1 for charging an electric vehicle 2 that is equipped with a traction battery system 2A. The traction battery system 2A has as components the traction battery BAT as such, and the charging electronics ELE.

The charging infrastructure 1 comprises a property, in this example: a single-family home 3, with a local energy network (“home energy grid 4”) for supplying electrical end consumers 5 with electrical power. A photovoltaic system 6, a stationary electrical intermediate storage unit (“stationary storage unit 7”) and a charging point in the form of a wallbox 8 are also integrated in the home energy network 4. The stationary storage unit 7 can be integrated in the photovoltaic system 6 in a further development. The home energy grid 4 is connected to a public electricity grid or energy supply grid 10 via a measuring point or a grid connection point in the form of a so-called “smart meter” 9.

The electric vehicle 2 can be connected to the wallbox 8 for bidirectional charging (i.e. optional charging and discharging), e.g. via a charging cable. It can then serve as an intermediate storage unit for the domestic power grid 4 within certain charging parameters and be charged and discharged accordingly. The wallbox 8 and the electric vehicle 2 can exchange data, e.g. via ISO 15118-2 and/or ISO 15118-20. In particular wallbox 8 receives charging parameters from the electric vehicle 2 such as a battery capacity, a specified or estimated departure time, a target SoC at the time of departure, a maximum charging power, a minimum SoC to be maintained, etc.

The home energy system 4 also includes an energy management system (“home energy management system or HEMS 11”), which is used to control a charging process of the stationary management system or HEMS 11″), which is used to control a charging process of the stationary storage unit 7 and which, when connected, operates as an intermediate storage unit BAT. HEMS 11, from a technical point of view and if possible, is connected at least to one of the users 5, the photovoltaic system 6, the stationary storage unit 7 and the wallbox 8, as indicated by the dotted lines.

HEMS 11 can receive its charging parameters via the wallbox 8 or directly from the electric vehicle 2. In the present example, it is assumed that smart meter 9 is connected to wallbox 8 via data technology, whereby in one variant HEMS 11 can then be connected to smart meter 9 via the wallbox 8 through data technology, that is it can retrieve its measured values. Alternatively or additionally, HEMS 11 can be connected directly to the “smart meter” 9 in terms of data technology. In general, a private meter belonging to the single-family home 3 (not shown) can be used instead of a smart meter 9, for example because the metering point operator does not use a smart meter but a simple electricity meter, or because the metering point operator cannot or does not want to share the measurement data of the smart meter 9 with the operator.

The smart meter 9 is also data-coupled with the metering point operator 12A, to which it transmits its metering data, for example. The smart meter 9 can also be data-coupled with at least one energy supplier of an energy market 12B, which transmits its metering data, for example it offers electricity or energy to the domestic energy grid 4 in accordance with specific-possibly time-variable-tariff information for purchase from the energy supply grid 10, and also sets feed-in prices for feeding a surplus of electrical energy from the domestic energy network 4 into the energy supply network 10. The energy supplier can provide the tariff information and, if applicable, other electricity information such as environmental information (e.g. information on CO emissions of the energy purchased) to the smart meter 9, namely current electricity information and/or a corresponding electricity information forecast. The energy market 12B can include, for example, other energy suppliers, energy aggregators, energy markets, grid system service markets, external market participants, etc. as additional participants. Participants of electricity market 12, for example, can work together with grid operators and metering point operators.

In the present case, the charging infrastructure 1 also has an external instance 13, e.g. a cloud computer or a network server, which for example serve as a so-called “backend”.

The external instance 13 can, for example, be an IT system maintained or operated by a manufacturer of the electric vehicle 2 and is then also referred to as the vehicle “backend”. The external instance 13 can be directly connected to electric vehicle 2, wallbox 8, HEMS 11 and/or a user terminal 14, e.g. a mobile user terminal such as a smartphone or tablet PC, for example wirelessly.

HEMS 11 can generate a charging plan (including a charging and discharging schedule) based on a forecast of consumption in the domestic energy grid 4, a forecast of energy generation by the photovoltaic system 6 (for example also when using weather forecasts) and the electricity information transmitted by the energy market participant 12B (in summary a charging and discharging) of the stationary storage device 7 and the electric vehicle 2 until the expected departure time of the electric vehicle 2, in order to influence the current flow through smart meter 9 for optimizing at least one predetermined purpose, for example for optimizing costs or minimizing CO emissions. The charging schedule for electric vehicle 2 created by HEMS 11 also takes into account the charging parameters and charge conditions set by electric vehicle 2. The charging plan for electric vehicle 2 can, for example, be transmitted from the HEMS 11 to the wallbox 8, which then executes this charging plan together with electric vehicle 2. Alternatively, the charging plan can be created by electric vehicle 2, wallbox 8 or external instance 13.

When creating the charging plan, the acquisition costs C_{bat} and Cₑₗₑ and the rated values E_{rated} and L_{rated} of the traction battery system 2A are taken into account, optionally also the acquisition costs C_{EVSE} and the rated operating life L_{EVSE} rated wallbox 8.

The variables C_{bat}, Cₑₗₑ, E_{rated} and L_{rated} can, for example, be transmitted from the electric vehicle 2 to the HEMS 11 and/or to the external instance 13, or these variables can be stored in the external instance 13 and transmitted to the HEMS 11, etc.

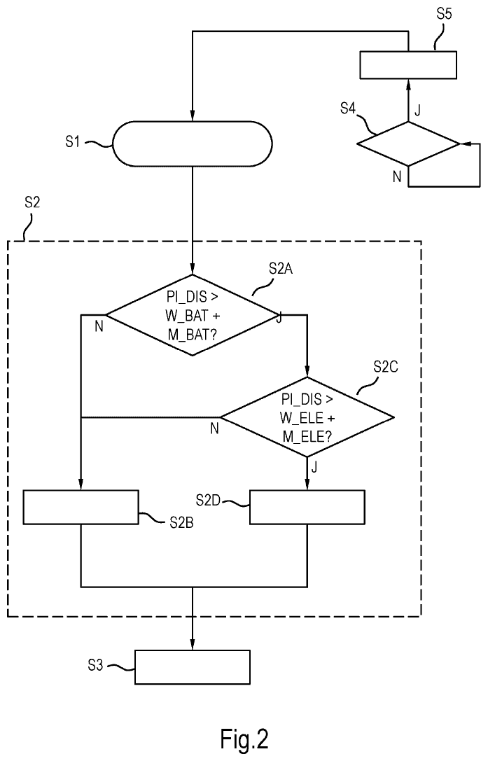

FIG. 2 shows a possible sequence for creating a loading plan using the charging infrastructure 1.

In step S1, before the preparation of the charging plan the acquisition costs Chat, Cₑₗₑ and, if applicable, C_{EVSE} as well as the nominal values E_{rated}, L_{rated} and, if applicable, L_{EVSE}, rated are prepared for HEMS 11 (or one of the other components 00002, 8, 13 of the charging plan).

In a step S2, a charging plan is set up which uses information, in particular a forecast, regarding the size of the discharge revenue or per unit of time for the expected connection time of the electric vehicle 2 at wallbox 8. The amount of the discharge revenue ndis or per unit of time can vary over the connection period, e.g. because a feed-in tariff fluctuates over the course of the day, own energy generation fluctuates over the course of the day, for example due to fluctuating solar radiation, etc.

In step S2A, if the discharge yield πdis, PI_DIS, is not greater by at least a predetermined margin M_{bat}, M_BAT than the battery charging wear costs W_{bat}, W_BAT (“N”), discharging of the traction battery BAT during the charging process is prevented (Step S2B), otherwise (“J”) the process proceeds to step S2C. The charging process can have one or more charging phases as well as one or more discharging phases.

Step S2C checks whether the discharge revenue or at least a predetermined margin Mele, M_ELE, is greater than the charging electronics charging wear costs Wₑₗₑ, W_ELE. If this is not the case (“N”), step S2B is carried out and discharging of the traction battery BAT during the charging process is prevented.

However, if this is the case (“J”), the system proceeds to step S2D and discharging of the traction battery BAT is permitted. This does not mean that the charging plan then drawn up must include a discharging phase, but it may do so if the conditions in steps S2A and S2C are both met. If the costs of wallbox 8 for discharging should also be taken into account, W_{sys} and M_{sys} can be used instead of Wₑₗₑ and Mₑₗₑ in step S2C.

Preventing the traction battery BAT from discharging during the charging process may mean that the charging plan has no discharge phases or that it is set up or modified in such a way that the two conditions are met.

Once the charging plan has been created, the electric vehicle 2 can be charged in step S3.

Step S4 is checked by the external instance 13 at the same time as steps S1 to S3, whether a predefined calculation period for calculating or determining the battery charging costs WLS or W_{bat} has expired. The calculation period can for example be hours, days, weeks or months. If this is not yet the case (“N”), the test is continued.

However, if this is the case (“J”), in step S5 the acquisition costs and/or nominal values of the traction battery system 2A and possibly additionally of wallbox 8 are adjusted by means of the external instance 13 on the basis of at least one influencing variable affecting wear of the traction battery system 2A and possibly of wallbox 8, for example on the basis of the number of charging and discharging cycles, an electrical power of the charging cycles, a calendar ageing, service life with high storage levels, the average state of charge; and/or an (e.g. ambient and/or cell) temperature.

At least some of these influencing variables can be tapped by the external instance 13 during a charging process of electric vehicle 2 from electric vehicle 2, for example, directly or over wallbox 8 and/or HEMS11. At least some of these influencing variables can additionally or alternatively be tapped by the electric vehicle 2 outside of a charging process. The charging wear costs are adapted from this and provided again in step S1. This provision can include transmitting the charging wear costs to the electric vehicle 2, wallbox 8 and/or HEMS 11.

Of course, the present invention is not limited to the design shown.

In general, “one”, “a unit” etc. can be understood as singular or plural, in particular in the sense of “at least one” or “one or more” etc., as long as this is not explicitly excluded, e.g. by the expression “exactly one” etc.

A number specification can also include exactly the specified number as well as a usual tolerance range, as long as this is not explicitly excluded.

### LIST OF REFERENCE SYMBOLS

1 Charging infrastructure
2 Electric vehicle
2A Traction battery system
3 Single-family home
4 Home energy system
5 End consumer
6 Photovoltaic system
7 Stationary storage
8 Wallbox
9 Smart meter
10 Energy supply network
11 HEMS
12A Metering point operator
12B Energy market
13 External instance
14 User terminal
BAT Traction battery
ELE Charging electronics
Gdis Discharge proceeds
M Margin
S1-S5 Process steps
W_BAT Battery charging wear costs W_{bat}
WLS Charging system charging wear costs

1-11. (canceled)

12. A method for bidirectional charging of an electric vehicle equipped with a traction battery system, where the traction battery system has a traction battery and charging electronics (ELE) provided for charging the traction battery, the method comprising:
determining, before a charging process, battery charging wear costs W_{bat} (W_BAT) of the traction battery (BAT) and charging electronics charging wear costs Wₑₗₑ (W ELE) of the charging electronics; and
preventing discharging of the traction battery (BAT) during the charging process at least for periods of time in which an associated discharge revenue (PI_DIS) is not greater than both the battery charging wear cost and the charging electronics charging wear costs by at least one predetermined margin (M_BAT, M_ELE) in each case,
wherein the battery charging wear costs W_{bat} (W_BAT) is calculated using the equation:
$${W}_{bat} = \frac{{C}_{bat}}{{E}_{rated}} Δ {E}_{dis}$$
and the charging electronics charging wear costs Wₑₗₑ (W_ELE) is calculated using the equation:
$${W}_{ele} = \frac{{C}_{ele}}{{L}_{rated}} Δ {t}_{dis}$$
where C_{bat} is an acquisition cost of the traction battery (BAT), E_{rated} is the estimated nominal total energy throughput of the traction battery (BAT) over its service life, ΔE_{dis} is an energy throughput during discharge, Cₑₗₑ is an energy throughput during charging and discharging of the traction battery (BAT), Cₑₗₑ is a cost of the charging electronics (ELE), L_{rated} is an estimated rated operating life of the charging electronics (ELE), and Δtd is a duration of the discharge.

13. The method according to claim 12, wherein the nominal total energy throughput, E_{rated}, is determined on the basis of at least one parameter which influences the wear of the traction battery (BAT).

14. The method according to claim 13, in which the nominal total energy throughput is adjusted, depending on at least one influencing variable from the group of influencing variables:
a number of charging phases;
a battery temperature during charging;
a temperature during standing times;
a performance of the charging process;
a calendar aging;
a medium storage level; and
a service life with high storage levels.

15. The method of claim 12, wherein the rated operating life, L_{rated}, of the charging electronics is adapted on the basis of at least one influencing variable which influences the wear of the charging electronics.

16. The method according to claim 15, wherein the rated operating life, L_{rated}, of the charging electronics (ELE) is adjusted depending on at least one influencing variable from the group of influencing variables:
a number of charging phases;
a power of the charging or discharging process;
a calendar aging;
a temperature during the charging process; and
a temperature adjustment.

17. The method according to claim 12, wherein:
the electric vehicle is connected to a charging point of a local energy grid at a home system in order to carry out the charging process and the charging point charging wear costs, W_{EVSE}, of the charging point incurred during discharging are calculated according to the equation:
$${W}_{EVSE} = \frac{{C}_{EVSE}}{{L}_{EVSE , rated}} Δ {t}_{dis}$$
where C_{EVSE} is an acquisition cost of the charge point or its electronics, L_{EVSE,rated} is an estimated nominal operating life of the electronics of the charge point, and Δt_{dis} is a duration of the discharge; and
preventing discharging of the traction battery during the charging process at least for periods of time at which a discharge rate Gdis (PI_DIS) is not greater than a sum of the charging electronics charging wear costs Wₑₗₑ (W_ELE) and the charging point charging wear costs, W_{EVSE} (S2C), by at least a specified margin.

18. The method according to claim 13, wherein at least one of the acquisition costs and/or at least one of the nominal values is regularly adjusted.

19. The method according to claim 18, in which at least one of the acquisition costs and/or at least one of the nominal values are adjusted by means of an external data processing instance which can be communicatively coupled to the electric vehicle.

20. An electric vehicle with a traction battery system, wherein the electric vehicle is configured for bidirectional charging of its traction battery (BAT) and wherein the electric vehicle is configured to perform the method according to claim 12.

21. A system comprising:
an electric vehicle with a traction battery system, wherein the electric vehicle is configured for bidirectional charging of its traction battery (BAT) and wherein the electric vehicle is configured to perform a method for bidirectional charging of an electric vehicle equipped with a traction battery system, where the traction battery system has a traction battery and charging electronics (ELE) provided for charging the traction battery, the method comprising:
determining, before a charging process, battery charging wear costs W_{bat} (W_BAT) of the traction battery (BAT) and charging electronics charging wear costs Wₑₗₑ (W ELE) of the charging electronics; and
preventing discharging of the traction battery (BAT) during the charging process at least for periods of time in which an associated discharge revenue (PI_DIS) is not greater than both the battery charging wear cost and the charging electronics charging wear costs by at least one predetermined margin (M_BAT, M_ELE) in each case,
wherein the battery charging wear costs W_{bat} (W_BAT) is calculated using the equation:
$${W}_{bat} = \frac{{C}_{bat}}{{E}_{rated}} Δ {E}_{dis}$$
and the charging electronics charging wear costs Wₑₗₑ (W_ELE) is calculated using the equation:
$${W}_{ele} = \frac{{C}_{ele}}{{L}_{rated}} Δ {t}_{dis}$$
where C_{bat} is an acquisition cost of the traction battery (BAT), E_{rated} is the estimated nominal total energy throughput of the traction battery (BAT) over its service life, ΔE_{dis} is an energy throughput during discharge, Cₑₗₑ is an energy throughput during charging and discharging of the traction battery (BAT), Cₑₗₑ is a cost of the charging electronics (ELE), L_{rated} is an estimated rated operating life of the charging electronics (ELE), and Δtd is a duration of the discharge; and
an external data processing instance which can be communicatively coupled to the electric vehicle and is configured to adjust at least one of the acquisition costs and/or at least one of the nominal values;
wherein the system the being set up to carry out the method of claim 19.

22. The system according to claim 21, further comprising:
a local energy grid comprising a charging point, which is configured for bidirectional charging of the electric vehicle; and
at least one regenerative energy generation device, wherein the discharge revenue (PI_DIS) is calculated taking into account that the power generation generated by the energy generation device that is fed into the local energy grid.
